(19) United States
(12) Patent Application Publication
(10) Pub. No.: US 2026/0280179 A1
(43) Pub. Date: Sep. 17, 2026

(54) CHARGING FLAP MODULE FOR AN ENERGY SUPPLY CONNECTION OF A MOTOR VEHICLE

(71) Applicant: BOS GmbH & Co. KG, Ostfildern (DE)

(72) Inventor: György MOLNAR, Kirchentellinsfurt (DE)

(21) Appl. No.: 19/168,576

(22) PCT Filed: Mar. 5, 2024
(86) PCT No.: PCT/EP2024/055667

§ 371 Date: Sep. 24, 2025

(30) Foreign Application Priority Data
Apr. 19, 2023 (DE) 10 2023 109 910.8

(51) Int. Cl. H01R 13/447; B60L 53/16; H01R 24/76

(52) U.S. Cl. CPC H01R 13/447; B60L 53/16; H01R 24/76; H01R 2201/26

(57) ABSTRACT

A charging flap module for an energy supply connection of a motor vehicle having a basic housing fittable to the vehicle and in a fitted state surrounding the energy supply connection, a charging flap movable between a closed position closing an energy supply opening and an open position exposing the energy supply opening with a control mechanism, and a locking device mechanically locking the charging flap in the closed position. The locking device has a locking element movable between a blocking position and a release position, and a drive system moves the locking element and the charging flap. A drive motor drives a control disk, mounted rotationally about an axis of rotation and having driving cams, which cams are operatively connected to the control mechanism and to the locking element, in order to move the charging flap and the locking element between respective end positions.

The invention relates to a charging flap module for an energy supply connection of a motor vehicle, with a basic housing fixedly fittable to the vehicle which in the fitted state surrounds the energy supply connection; with a charging flap which is movable between a closed position closing an energy supply opening and an open position exposing the energy supply opening by means of a control mechanism; with a locking device for mechanically locking the charging flap in the closed position, wherein the locking device has at least one locking element movable between a blocking position and a release position; and with a drive system for moving the at least one locking element and the charging flap, which has a drive motor.

A charging flap module of this type is known from DE 10 2019 128 551 A1 . The known charging flap module has a charging flap which is swivelably mounted relative to a housing fixedly fittable to the vehicle. The housing surrounds an energy supply connection for the motor vehicle. The charging flap is, in a closed position, additionally locked relative to the housing by a sliding bar. A drive system having an electric drive motor is provided for swiveling the charging flap and controlling the sliding bar. The electric drive motor drives a toothed pinion which meshes with a swivel gearing that effects the swivel movement of the charging flap. The drive pinion of the electric drive motor is also coaxially coupled to an eccentric control cam which interacts mechanically with a control receptacle of the sliding bar. The control cam is rotationally locked with the drive pinion and is accordingly rotated together with the drive pinion when the electric drive motor is activated. The swivel gearing is arranged radially offset from the drive pinion, wherein a swivel axis of the swivel gearing, and hence of the charging flap, is aligned parallel to the axis of rotation of the drive pinion and of the control cam.

The object underlying the invention is to provide a charging flap module of the type mentioned at the outset which permits easy and dependable control of the charging flap and of the locking device in a compact design.

This object is achieved in that the drive motor drives a control disk, mounted rotationally about an axis of rotation and provided with driving cams parallel to the axis of rotation and projecting from at least one end face of the control disk, which cams are in a mechanically operative connection to the control mechanism of the charging flap and to the at least one locking element, in order to move the charging flap and the locking element between the respective end positions. The term ‘control disk’ is used herein to generally mean a rotationally symmetrical body whose diameter is greater than its thickness along a corresponding axis of rotation. Driving cams is used herein to mean raised portions that project from the appropriate end face of the control disk parallel to the axis of rotation. The solution in accordance with the invention is suitable for energy supply connections of motor vehicles of differing type, wherein a corresponding energy supply is intended for the movement drive of the respective motor vehicle. The charging flap module in accordance with the invention is usable for purely electrically operated motor vehicles in the same way as for hybrid motor vehicles operated with a combination of electric motor and internal combustion engine drive, and for motor vehicles operated exclusively by an internal combustion engine. In the latter case, the energy supply connection is designed as a tank nozzle for fuel filling. Motor vehicles herein refer to passenger cars, commercial vehicles, trucks or even waterborne vehicles or aircraft. The driving cams are firmly connected to the control disk, resulting on the one hand in a compact arrangement and on the other hand in a sturdy and easy to manufacture charging flap module.

In one embodiment of the invention, the driving cams are arranged offset to one another in the circumferential direction such that during a rotary movement of the control disk, the control mechanism of the charging flap and the at least one locking element are activated at different times to one another. This ensures dependable locking or unlocking of the charging flap after or before a corresponding movement of the charging flap was ended or commenced.

In a further embodiment of the invention, the driving cams for the control mechanism of the charging flap are in an operative connection to the control mechanism by means of a freewheel limited in its angle of rotation. The freewheel assists differently timed movement of the charging flap and of the locking element, without a drive force of the drive motor having to be interrupted.

In a further embodiment of the invention, the freewheel has a freewheel element rotatably mounted coaxially to the control disk and spring-loaded in the direction of rotation. The freewheel element arranged coaxially to the axis of rotation of the control disk, which is freely rotatable relative to the control disk, permits a particularly compact design of the charging flap module.

In a further embodiment of the invention, two driving cams offset to one another in the circumferential direction of the control disk are provided and form end stops for the freewheel element in both directions of rotation, and the freewheel element is provided with profiled stops complementary to the driving cams and at a distance from one another with a larger angle of rotation than the two driving cams relative to one another. As a result, the freewheel element has limited rotatability independently of the control disk. The limitation of rotatability is effected by the driving cams of the control disk, which interact with the profiled stops of the freewheel element. The freewheel element is preferably designed as a flat disk or plate element.

In a further embodiment of the invention, a further driving cam for activating the locking element is arranged at a different radial distance from the axis of rotation on the control disk than the driving cams for the control mechanism of the charging flap, and/or the further driving cam has a greater length parallel to the axis of rotation than the two driving cams of the control mechanism of the charging flap. The position of the further driving cam, preferably arranged further outwards radially, for activating the locking element ensures that this further driving cam does not affect the rotatability of the freewheel element. The greater length of this further driving cam permits, during a corresponding rotary movement of the control disk, mechanical interaction of this further driving cam with the locking element, without the locking element impairing the rotary movement of the control disk, and hence of the first and second driving cams, or the rotation of the freewheel element.

In a further embodiment of the invention, the control mechanism of the charging flap has a control lever rotatably mounted coaxially to the control disk and joined to the charging flap. The coaxial arrangement of the control lever relative to the axis of rotation of the control disk also contributes to a compact design of the charging flap.

In a further development of the invention, the freewheel disk is arranged in the rotation plane of the control lever. As a result, the freewheel disk drives the control lever too in the corresponding direction of the movement to be performed by the control lever and hence by the charging flap.

Further advantages and features of the invention can be found in the claims and in the following description of a preferred example of the invention that are explained on the basis of the drawing.

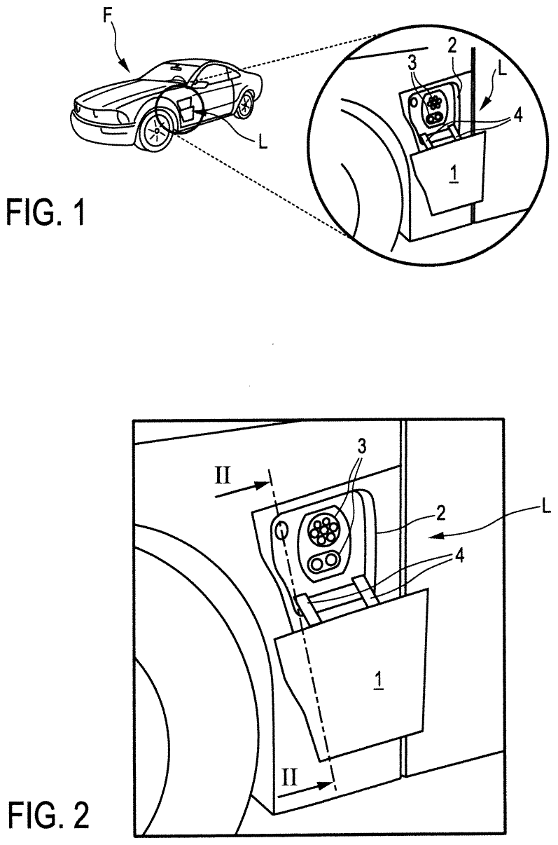

FIG. 1 shows schematically a passenger car with an embodiment of a charging flap module in accordance with the invention in an enlarged view,

FIG. 2 the charging flap module according to FIG. 1 in a further enlarged and exploded view,

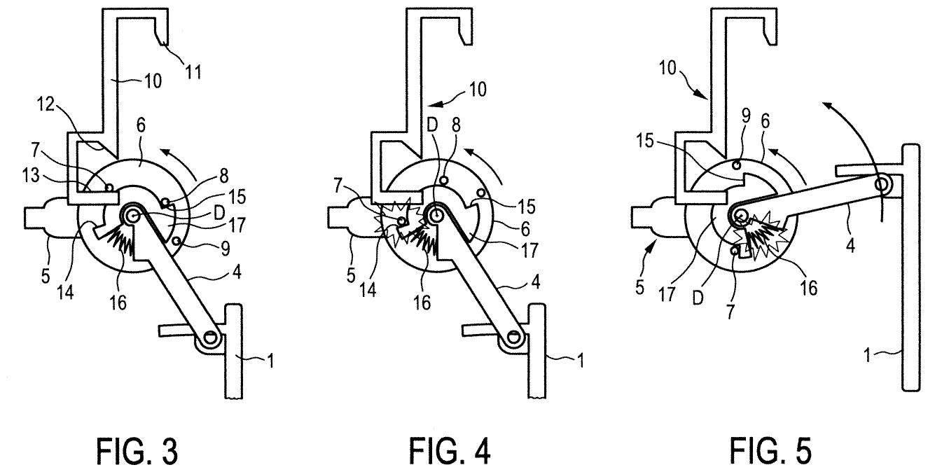

FIG. 3 a schematic sectional view along the section line II-II in FIG. 2 in an open position of a charging flap,

FIGS. 4 to 8 the view according to FIG. 3 in different positions during a closing movement of the charging flap and

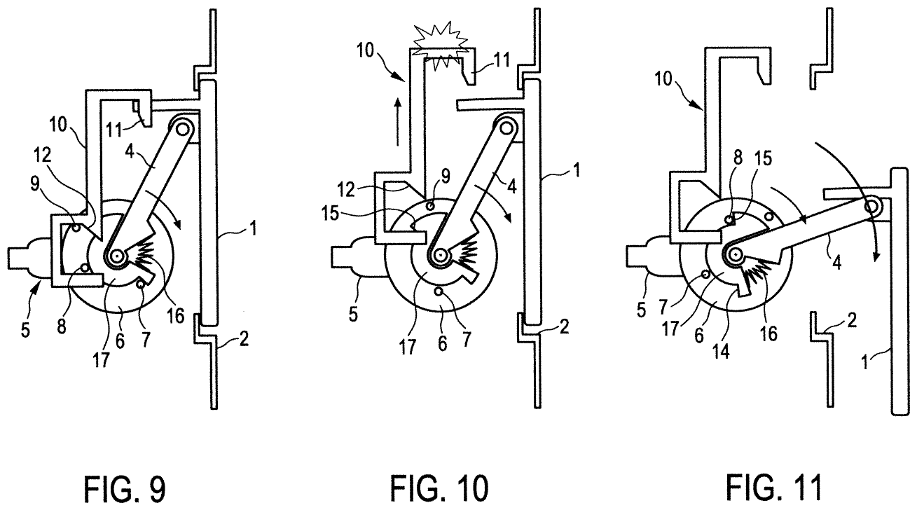

FIGS. 9 to 12 the schematic view matching FIGS. 3 to 8 in different positions starting from the closed position up to the open position of the charging flap.

A passenger car F has, according to FIG. 1, a charging flap module L, which is provided with two power charging connections 3, in front of a side door on the left when viewed in the direction of travel, on a lateral bodywork area. The power charging connections 3 form energy supply connections in the meaning of the invention. The charging flap module L has a housing 2 surrounding the power charging connections 3 and connected fixedly to corresponding bodywork structure parts of the passenger car F. The housing 2 forms a power charging opening representing an energy supply opening in the meaning of the invention. The power charging opening is closable by a charging flap 1. In a closed position, the charging flap 1 completely covers the power charging opening of the housing 2. The charging flap 1 is also integrated flush into an outer bodywork surface of the passenger car F in the closed position.

The charging flap 1 is mounted on a control mechanism having at least one control lever 4. The control mechanism is used to move the charging flap 1 between the closed position and an open position as shown in FIGS. 1 and 2. The charging flap 1 remains permanently coupled to the control mechanism during a corresponding movement.

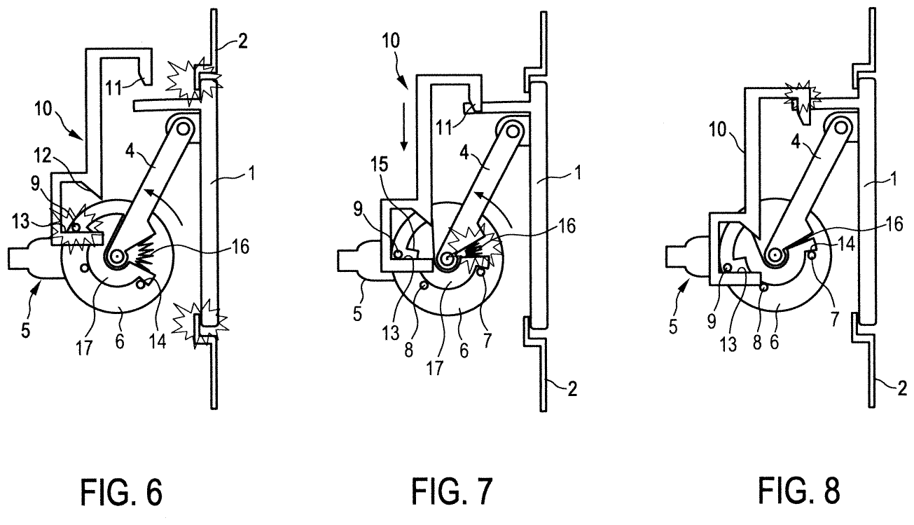

In the closed position, the charging flap 1 is additionally locked by a locking device having a locking element 10 shown schematically in FIGS. 3 to 12. The locking element 10 is mounted in linearly movable manner in the housing 2 between a blocking position (FIGS. 8 and 9) and a release position (FIGS. 6 and 10). A drive system having an electric drive motor 5 is provided for moving the charging flap 1 between the closed position and the open position and for moving the locking element 10 between the blocking position and the release position (FIGS. 3 to 12).

To move the charging flap 1 and the locking element 10, the drive motor 5 drives a control disk 6 which is mounted rotatably about an axis of rotation D. In the embodiment according to FIGS. 3 to 12, the control disk 6 is designed circular. Several driving cams 7 to 9 are fixedly arranged on an end face of the control disk 6, facing the beholder in the drawings according to FIGS. 3 to 12. The two driving cams 7 and 8 are designed pin-like and are arranged on the control disk 6 at the same radial distance from the axis of rotation D. In the circumferential direction of the control disk, the two driving cams 7 and 8 are at a distance from one another over an angle of rotation of 110°. Both driving cams 7 and 8 are provided parallel to the axis of rotation D, and hence projecting orthogonally from the end face of the control disk 6, and have identical lengths.

A further driving cam 9, which is positioned at a greater radial distance from the axis of rotation D than the two driving cams 7 and 8, is arranged fixedly on the control disk 6. The further driving cam 9 also has a greater axial length than the two driving cams 7 and 8. The further driving cam 9 too is aligned parallel to the axis of rotation D and projecting orthogonally to the end face of the control disk 6.

The control lever 4 is likewise mounted rotatably about the axis of rotation D and projects radially outwards from the axis of rotation D. A length of the control lever 4 corresponds to approximately 2.5 times the radius of the control disk 6.

To transmit rotary movements of the control disk 6 to the control lever 4, a freewheel element 17 is provided, which is also mounted rotatably coaxially to the axis of rotation D. Both the control lever 4 and the freewheel element 17 are rotatably arranged independently of the control disk 6.

The freewheel element 17 has a contour arc-shaped relative to the axis of rotation D and limited by two profiled stops 14 and 15 at the ends in the circumferential direction. The thickness of the freewheel element 17 corresponds at least largely to a thickness of the control disk 6, so that the freewheel element forms a plate-like or disk-like component. These profiled stops 14 and 15 project radially to the axis of rotation D in stepped manner and are provided at a radial distance from the axis of rotation D which corresponds at least largely to the radial distances of the driving cams 7 and 8. The arc-shaped outer contour of the freewheel element 17 in the circumferential direction between the two profiled stops 14 and 15 has a radius which is slightly smaller than the distance of the driving cams 7 and 8 from the axis of rotation D. The freewheel element 17 is accordingly limited in its rotation relative to the control disk 6, wherein the limitation is effected in both directions of rotation by the contact of the profiled stops 14 and 15 with the driving cams 7 and 8. The freewheel element 17 also has a driver flank, not described in detail, which contacts the control lever 4 during a clockwise movement—with reference to the illustrations according to FIGS. 3 to 12—and also drives said lever. Finally, the freewheel element 17 has an opposite supporting flank, also not described in detail, on which is supported a compression spring 16 which is supported on the opposite side on a corresponding section of the control lever 4. Accordingly, when the freewheel element 17 rotates in a counter-clockwise direction, the compression spring 16 exerts a torque on the control lever 4 in the counter-clockwise direction in similar manner. The compression spring 16 is compressible such that there is limited relative rotatability between the supporting flank of the freewheel element 17 and the associated section of the control lever 4.

The locking element 10 has control surfaces 12 and 13 that project into the movement path of the further driving cam 9, wherein the one control surface 12 is used, in an operative connection to the further driving cam 9, to move the locking element 10 out of the blocking position and into the release position. The other control surface 13 is used to move the locking element 10 out of the release position into the blocking position in an operative connection to the further driving cam 9. The control surfaces 12 and 13 are arranged axially to the axis of rotation D at a distance from the control disk 6 sufficiently large for the driving cams 7 and 8 to rotate through, underneath these control surfaces 12 and 13 of the locking element 10. The further driving cam 9 by contrast contacts—depending on the direction of rotation of the control disk 6—the one or the other control surface 13, 12, in order to move the locking element 10 in corresponding manner.

To move the charging flap 1 out of the open position according to FIGS. 1 and 2 in the direction of the closed position, the control disk 6 is, according to FIGS. 3 to 8, driven in the counter-clockwise direction by means of the drive motor 5 (see direction of arrow). Corresponding end positions, or stop or contact points, are symbolized in the drawings by spikey bubbles. The driving cam 7 here contacts the profiled stop 14 of the freewheel element 17 (FIG. 4), so that the freewheel element 17 is also driven in the counter-clockwise direction. The pressure of the compression spring 16 acts on the control lever 4 also in the counter-clockwise direction, so that the control lever 4 too is rotated in the counter-clockwise direction (FIG. 5) and the charging flap 1 is driven in the direction of the closed position. As soon as the charging flap 1 contacts the housing 2 (FIG. 6), the further control cam 9 contacts the control surface 13 of the locking element 10. During a further rotary movement of the control disk 6 by means of the drive motor 5 in the counter-clockwise direction (FIG. 7) and corresponding driving of the freewheel element 17, the compression spring 16 is necessarily compressed, since the charging flap 1 is already resting on a rim of the power charging opening of the housing 2. The further rotary movement of the control disk 6 in the counter-clockwise direction also leads to the further driving cam 9 moving the locking element 10 in the direction of the blocking position, i.e. in the direction of the arrow (FIG. 7). In the blocking position (FIG. 8) of the locking element 10, the end position of the control disk 6 is reached so that the drive motor 5 switches off.

If the charging flap 1 is to be reopened, starting from this end position in which the charging flap 1 is in its closed position and in which the locking element 10 is moved into its blocking position (FIG. 9), the control disk 6 is driven in the correspondingly reversed clockwise direction according to FIGS. 9 to 12.

The locking element 10 has a locking pin 11 which drops into a locking recess, not shown in detail, of the charging flap 1 in the blocking position, as may be seen in FIGS. 7 to 9.

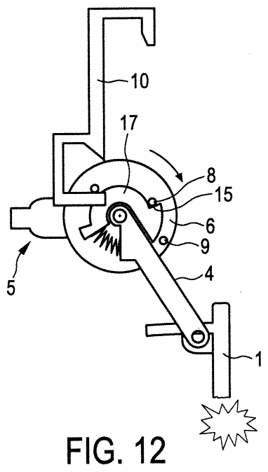

If the control disk 6 is driven in the clockwise direction by the drive motor 5, the further driving cam 9 moves away in the circumferential direction from the control surface 13 of the locking element 10 to the opposite control surface 12 of the locking element 10 (FIG. 9) designed as an inclined contact surface. During a further rotary movement, the control surface 12 necessarily slides along the further driving cam 9, with the result that the locking element 10 with its locking pin 11 is also necessarily moved out of the locking recess of the charging flap 1 (FIG. 10). Since, during this rotary movement in the clockwise direction, the driving cam 7 too necessarily rotates in the clockwise direction, the compression spring 16 is relieved again, and the driver flank of the freewheel element 17 contacts the control lever 4 in the clockwise direction. An active rotary movement acting on the freewheel element 17 does not take place until the driving cam 8 contacts the profiled stop 15 of the freewheel element 17 in the clockwise direction (FIG. 11). At this point in time, the locking element 10 has already moved into its release position, as can be seen in FIG. 10. The driving cam 8 now also drives the freewheel element 17 and the control lever 4 in the clockwise direction, as may be readily seen from the arrows shown in FIG. 11. As a result, the charging flap 1 moves away from the rim of the power charging opening of the housing 2 and in the direction of the open position. The open position of the charging flap 1 is reached, according to FIG. 12, when the charging flap 1 is contacting a corresponding part of the housing 2 or outer bodywork surface in this open position (FIG. 12).

1. A charging flap module for an energy supply connection of a motor vehicle, comprising:
a basic housing fixedly fittable to the vehicle, the basic housing in a fitted state surrounding the energy supply connection;
a control mechanism;
a charging flap movable between a closed position closing an energy supply opening and an open position exposing the energy supply opening via the control mechanism;
a locking device for mechanically locking the charging flap in the closed position, wherein the locking device has at least one locking element movable between a blocking position and a release position;
a control disk mounted rotationally about an axis of rotation and having at least one end face; and
a drive system for moving the at least one locking element and the charging flap, the drive system having a drive motor, the drive motor driving thee control disk, the control disk having driving cams parallel to the axis of rotation and projecting from the at least one end face, the driving cams being in a mechanically operative connection to the control mechanism and to the at least one locking element to move the charging flap and the at least one locking element between respective end positions.

2. The charging flap module according to claim 1, wherein the driving cams are arranged offset to one another in a circumferential direction such that during a rotary movement of the control disk, the control mechanism and the at least one locking element are activated at different times from one another.

3. The charging flap module according to claim 1, wherein the driving cams for the control mechanism are in an operative connection to the control mechanism by a freewheel limited in an angle of rotation.

4. The charging flap module according to claim 3, wherein the freewheel has a freewheel element rotatably mounted coaxially to the control disk and spring-loaded in a direction of rotation.

5. The charging flap module according to claim 4, wherein two of the driving cams are offset to one another in a circumferential direction of the control disk and form end stops for the freewheel element in two directions of rotation, and the freewheel element has profiled stops complementary to the two driving cams and distant from one another with a larger angle of rotation than the two driving cams relative to one another.

6. The charging flap module according to claim 5, wherein a third of the driving cams are for activating the at least one locking element and are arranged at a different radial distance from the axis of rotation on the control disk than the two driving cams for the control mechanism, and/or the third driving cam has a greater length parallel to the axis of rotation than the two driving cams of the control mechanism.

7. The charging flap module according to claim 1, wherein the control mechanism has a control lever rotatably mounted coaxially to the control disk and joined to the charging flap.

8. The charging flap module according to claim 7, wherein the driving cams for the control mechanism are in an operative connection to the control mechanism by a freewheel limited in an angle of rotation and the freewheel has a freewheel element rotatably mounted coaxially to the control disk and spring-loaded in a direction of rotation, the freewheel element being arranged in a rotation plane of the control lever.
